(19) United States
(12) Patent Application Publication
(10) Pub. No.: US 2026/0269679 A1
(43) Pub. Date: Sep. 10, 2026

(54) FAN WITH ELECTRIC MOTOR HAVING SEPARATED CONTROL DRIVE

(71) Applicants: WEG S.A., Jaraguá do Sul (BR); FanTR, Sorocaba (BR)

(72) Inventors: Thiago Piazera de Carvalho, Jaraguá do Sul (BR); Ricardo Reis Costa, Sorocaba (BR); Ramon Gomes da Silva, Jaraguá do Sul (BR); Daniel Strauss, Sorocaba (BR)

(21) Appl. No.: 19/073,605

(22) Filed: Mar. 7, 2025

(51) Int. Cl. H02K 5/20; F04D 19/00; F04D 25/06; F04D 27/00; F24F 13/20; H02K 9/06; H02K 11/33

(52) U.S. Cl. CPC H02K 5/207; F04D 19/002; F04D 25/06; F04D 27/00; F24F 13/20; H02K 9/06; H02K 11/33; F24F 2013/205

(57) ABSTRACT

A fan assembly with an electric motor, where the motor control drive is positioned on the external side of the fan casing and is cooled by ambient air. The fan casing has an opening on the fan low pressure side in the region that the control drive is positioned on the fan casing. In this way, the external air is sucked by the low pressure of the fan creating a forced airflow over the external surface of the control drive. This airflow allows the cooling of the control drive without requiring an additional auxiliary fan and without requiring the increase on the size of the control drive to allow its proper cooling. The present invention provides improved cooling of the control drive using ambient air, eliminating the need for an auxiliary fan and enhancing reliability and efficiency compared to prior art solutions.

### BACKGROUND OF THE INVENTION

### Field of the Invention

The present invention relates to electric motors for packaged fans.

### Description of the Background

Packaged fans are commonly used on applications requiring air movement to allow heat transfer such as in cooling towers, air coolers, condensers and evaporators. Such fans are typically used on cooling and refrigeration applications such as HVAC, industrial refrigeration, power generation, process cooling, steam condensing, data centers, food processing, meat and dairy production. A packaged fan usually consists of a rotor, an electric motor, a fan casing and a protection screen. The fan casing generally includes an inlet bell and can also include a pressure recovery stack. The integration of all these parts is critical to the performance of the packaged fan. There are many different designs for packaged fans available in the prior art including alternating current (AC) and electronically commutated (EC) electric motors. AC electric motors can be directly connected to an electric power source, while EC electric motors require a control drive. EC electric motors typically have the control drive integrated with the motor so the control drive is cooled by the air flow passing through the fan. Therefore, the control drive is subject to the same environmental conditions as the electric motor such as high temperature and/or high humidity. This situation is harmful to the control drive as its electronic components are sensitive to excessive temperature and humidity. This results in a limitation on the applications where EC motors can be used on packaged fans. One prior art solution for this limitation on the use of EC motors for packaged fans is to use an independent control drive positioned outside the fan casing. While this arrangement eliminates the problem of the influence of the fan air temperature and humidity, it also eliminates the possibility of using the fan air flow for the cooling of the control drive. Therefore, where an independent control drive has been situated outside the fan casing it is necessary to add an auxiliary fan to the control drive or to use very large heat exchange surfaces to cool the control drive without a forced air flow. This increases the cost of the solution and decreases the reliability due to the additional auxiliary fan and additional heat exchange surface added to the system. According to another prior art solution described in CN216278555, the control drive is removed from the motor and placed on a separate support inside the packaged fan as shown in FIG. 1. FIG. 1 shows a prior art fan assembly with an EC electric motor and a control drive integrated with the motor. The fan assembly includes a fan rotor, a fan casing, and a protection screen. The fan casing has an inlet bell and a pressure recovery stack. The fan assembly is mounted on a fan deck and is connected to an electric power source. According to this arrangement, the cooling of the control drive is improved in comparison to arrangements in which the control drive is attached to the motor, but its application is limited in that it cannot be used in cases of high temperature and/or humidity. Therefore, this solution has limited applicability and has an additional disadvantage that it creates an additional obstruction to the airflow inside the fan and consequently increases the fan internal pressure loss and reduces the fan energy efficiency.

Another prior art solution is described in EP2506698, where the control drive is separated from the motor and placed inside outer and inner fan housings. The control drive is cooled by the air flow passing through the inner housing fan and the fan duct has openings on the high-pressure side of the fan to bleed part of the air from the fan to the internal part of the control drive housing. However, the control drive still suffers from the limitation of applicability in the case of high temperature and/or humidity in the air flow. Moreover, the control drive and the inner and outer housings create additional obstructions to the air flow inside the fan and consequently increase the fan internal pressure loss and reduce the fan energy efficiency.

### SUMMARY OF THE INVENTION

The present invention provides a fan assembly with an electric motor, where the motor control drive is positioned on the external side of the fan casing. To cool the drive, the fan casing has an opening on the fan low pressure side opposite the location where the drive is positioned on the fan casing. In this way, the external air is sucked by the low pressure of the fan creating a forced airflow over the external surface of the control drive. This airflow allows the cooling of the control drive without requiring an additional auxiliary fan and without requiring the increase in the size of the control drive to allow its proper cooling. Since the air passing through the control drive is external ambient air, the present invention does not have the limitation of use in the cases of high temperature and/or humidity in the air passing through the fan. Therefore, the present invention is a simpler and lower cost solution than prior art arrangements for high temperature and/or humidity applications. Also, as an auxiliary fan is not necessary, the additional energy consumption of an auxiliary fan is avoided thereby reducing the total energy consumption required by the control drive. Additionally, with the present invention, the airflow over the control drive is generated whenever the fan is in operation due to its location on the low-pressure side of the fan. Therefore, the cooling of the control drive is obtained without the risk of overheating as in the case of prior art arrangements where the additional auxiliary fan is damaged or there is excessive dirt over the heat exchange surface of the motor drive. Consequently, the present invention is a more robust solution and has increased reliability relative to prior art arrangements.

In one embodiment of the present invention, the control drive is separated from the motor by adding an electric connection cable. With this, the heat of the motor is no longer transmitted to the control drive, which brings another advantage of the present invention as the heat rejection necessary on the control drive can be reduced and consequently the control drive is allowed to operate at higher power. The heat exchange of the motor itself is also improved by virtue of no longer having the control drive directly attached. Specifically, by separating the control drive from the motor housing, the heat generating components of the electric motor will be closer to the surface on which the wind driven by the fan directly passes by, reducing motor temperature. In another embodiment of the present invention, the control drive is enclosed in a casing that has an inlet opening from which the external ambient air can enter the casing and an outlet opening connected to the fan casing opening. This control drive casing directs the external ambient air to pass through the external surface of the control drive increasing the air velocity on the control drive and consequently increasing its cooling. The present invention may be used with electronically commutated (EC) motors, induction motors or reluctance motors with variable frequency drive (VFD). The present invention is applicable to any type of fan arrangement that uses an electric motor with a control drive, such as packaged fans for cooling towers, air coolers, condensers and evaporators.

### BRIEF DESCRIPTION OF THE DRAWINGS

FIG. 1 is a perspective view of a prior art fan assembly with the control drive separated from the motor and placed inside the fan casing.

FIG. 2 is a cross-sectional view of a prior art fan assembly with the control drive separated from the motor and placed inside a secondary housing adjacent the fan housing.

FIG. 3 is a schematic view of a fan assembly according to an embodiment of the present invention, with the control drive separated from the motor and placed on the external part of the fan casing with an opening on the low-pressure side of the fan.

FIG. 4 is a representation of a control drive integrated with a motor and a control drive separated from the motor but connected by a power cable.

FIG. 5 is a side elevational view of a fan assembly according to another embodiment of the present invention showing the control drive mounted on an outside surface of the fan casing.

FIG. 6 is a side elevational view of a fan assembly according to another embodiment of the invention in which the control drive is mounted an outside surface of the fan casing and contained inside a control drive casing.

FIG. 7 is another view of the embodiment of FIG. 6.

FIG. 8 is a view of the embodiment of FIGS. 6 and 7 with the control drive casing cover removed.

FIG. 9 is a view of a fan casing according to an embodiment of the invention showing openings in the low-pressure side of the fan casing in a location corresponding to the location of the exterior-mounted control drive.

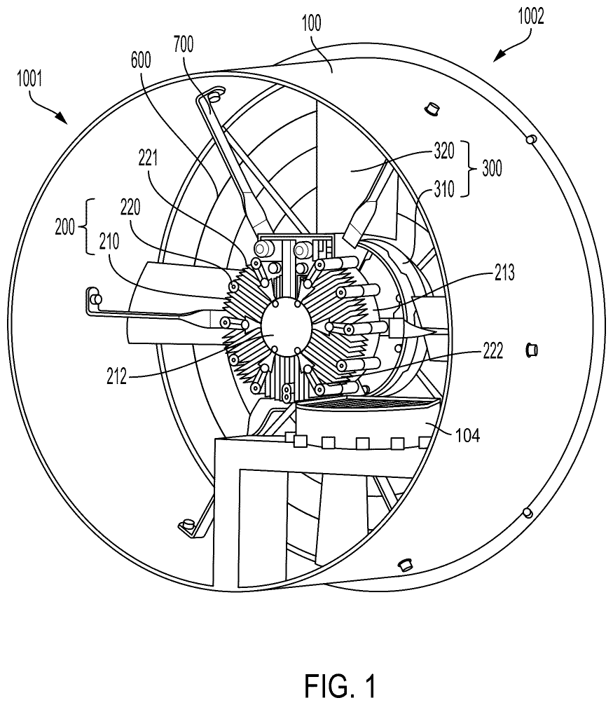

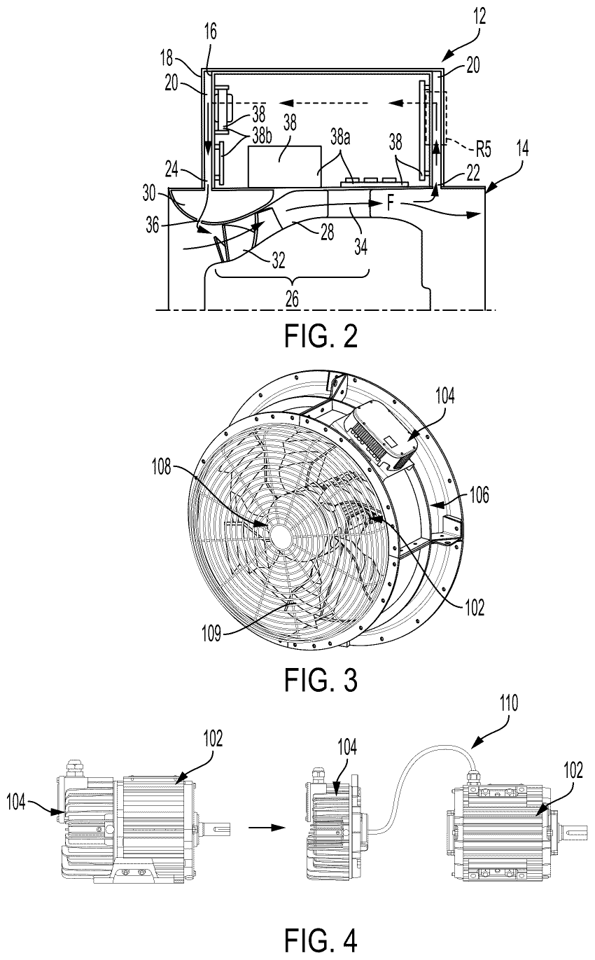

Elements shown in the drawings may be identified by the following numerical labels:

Fan assembly 100
electric motor 102
Control drive 104
Fan casing 106
Fan rotor 108
Fan blades 109
Connection cable 110
Fan casing openings 112
Control drive casing 114
Inlet openings 116
Outlet opening 118

### DETAILED DESCRIPTION OF THE INVENTION

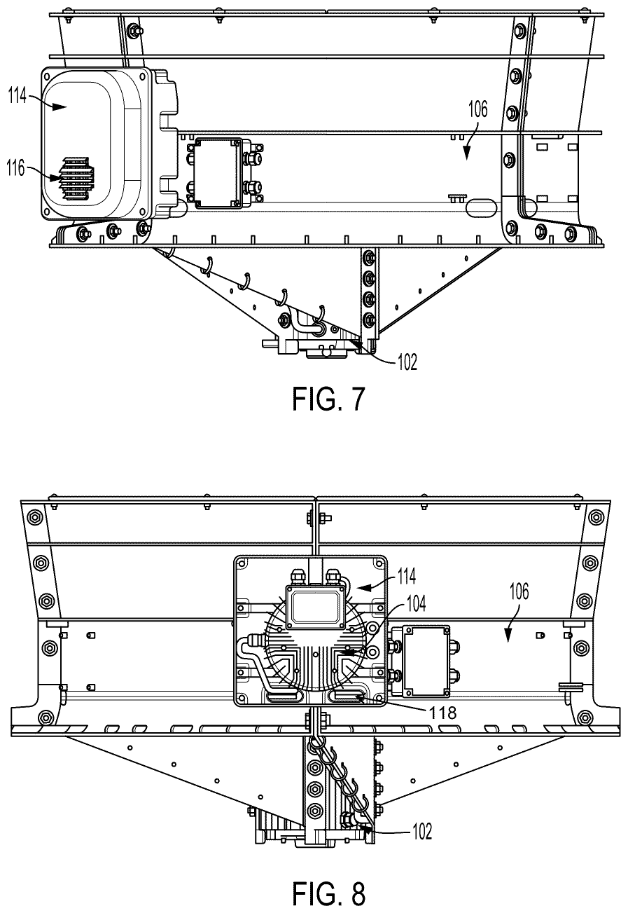

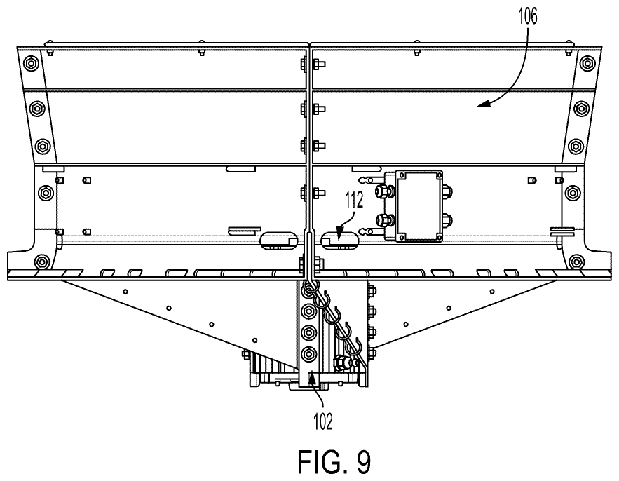

Referring to FIGS. 3-9, a various non-limiting preferred embodiments will now be described in more detail. FIG. 3 shows a fan assembly 100 according to an embodiment of the present invention, with an electric motor 102 and a control drive 104 separated from the motor 102 (see, e.g., FIG. 4) and placed on an external face of fan casing/fan shroud 106. The fan assembly 100 also includes a fan rotor 108 and fan blades 109. The control drive 104 is connected to motor 102 by an electric connection cable 110. The fan casing 106 has one or more openings 112 (FIG. 9) on the fan low pressure side corresponding to the location where the control drive 104 is positioned on the external face of the fan casing 106. In this way, the external air is sucked by the low pressure of the fan creating a forced airflow over the external surface of the control drive 104. This airflow allows the cooling of the control drive 104 without requiring an additional auxiliary fan and without requiring an increase on the size of the control drive 104 to allow its proper cooling. The airflow over the control drive 104 is generated whenever the fan is in operation due to the positioning on the low-pressure side of the fan. Since the air passing through control drive 104 is the external ambient air, the present invention does not have the use limitations of the prior art control drives.

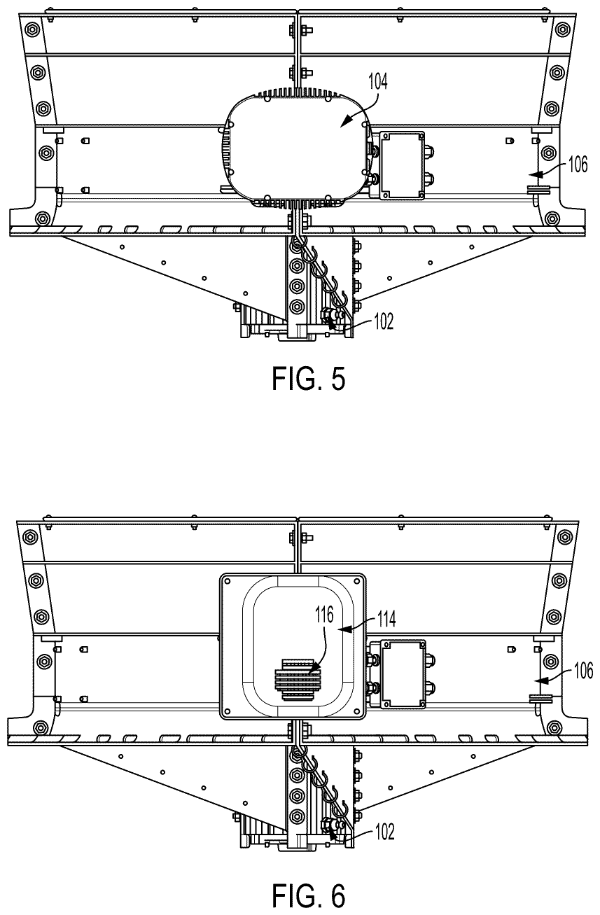

FIG. 5 shows a fan assembly 100 according to another embodiment of the present invention, with an electric motor 102 and a control drive 104 separated from the motor 102 and enclosed in a control drive casing 114. The fan assembly 100 also includes a fan rotor 108 and fan blades 109. The control drive casing 114 has one or more inlet openings 116 from which the external air can enter the control drive casing 114. The control drive casing may be completely open on the side facing the fan casing, or it may have one or more outlet openings 118 adjacent the fan casing 106 opening(s) 112. The control drive casing 114 directs the external ambient air to pass through the external surface of the control drive 104 increasing the air velocity on the control drive 104 and consequently increasing its cooling. As with the embodiment of FIG. 3, the fan casing 106 opening 112 is on the fan low pressure side corresponding to the location where the control drive 104 is positioned on the external face of the fan casing 106. In this way, the external air is sucked by the low pressure of the fan creating a forced airflow over the control drive 104.

The present invention provides improved cooling of the control drive using ambient air, eliminating the need for an auxiliary fan and enhancing reliability and efficiency compared to prior art solutions. The present invention is applicable to any type of fan assembly that uses an electric motor with a control drive, such as packaged fans for cooling towers, air coolers, condensers and evaporators.

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A fan assembly comprising:
a cylindrical fan casing having a primary air flow inlet and a primary air flow outlet, fan blades attached to a fan rotor mounted inside the fan casing and configured to create an air flow from the primary air inlet to the primary air flow outlet,
the fan assembly having a low pressure side between the primary air flow inlet and the fan blades and a high pressure side between the fan blades and the primary air flow outlet,
said fan assembly further comprising an electric motor attached to the fan rotor and configured to drive the fan rotor,
a control drive positioned on an external surface of the low pressure side of the fan casing, the control drive connected to the electric motor by a power cord and configured to control the electric motor,
wherein the fan casing defines an opening at a location corresponding to a position of said control drive and the rotation of the fan rotor and fan blades under power of the electric motor draws ambient air over the control drive through the fan casing opening and into a low pressure side of the fan casing, thereby cooling the control drive.

2. The fan assembly of claim 1, wherein the control drive is enclosed in a control drive casing that has an inlet opening configured for entry of the ambient air

3. The fan assembly of claim 2, wherein the control drive casing is completely open on a side facing the fan casing.

4. The fan assembly of claim 2, wherein the control drive casing has a back side that defines an opening opposite the fan casing opening to allow airflow from an interior of the control drive casing into the low pressure side of the fan casing.

5. The fan assembly of claim 1, wherein the fan assembly is a packaged fan for a cooling tower, an air cooler, a condenser or an evaporator.

6. The fan assembly according to claim 1, wherein the electric motor is an electronically commutated motor, an induction motor or a reluctance motor with a variable frequency drive.

7. A method of cooling a control drive of a fan assembly, the fan assembly comprising a fan casing having an inlet and an outlet, a fan rotor mounted inside the fan casing and configured to create an air flow from the inlet to the outlet, an electric motor connected to the fan rotor and configured to drive the fan rotor, and a control drive configured to control the electric motor, the method comprising: positioning the control drive on an external side of the fan casing in a region corresponding to an opening on the fan casing on a low pressure side of the fan; and allowing an external ambient air to enter the fan casing through the opening and pass over the control drive, thereby cooling the control drive.

8. The method of claim 6, further comprising enclosing the control drive in a casing that has an inlet opening from which the external ambient air can enter the casing and an outlet opening connected to the opening on the fan casing, wherein the casing permits the external ambient air to pass across an external surface of the control drive.

9. The method of claim 6, wherein the fan assembly is a packaged fan for a cooling tower, an air cooler, a condenser or an evaporator.

10. The method according to claim 6, wherein the electric motor is an electronically commutated motor, an induction motor or a reluctance motor with a variable frequency drive.
